(19) United States
(12) Patent Application Publication
(10) Pub. No.: US 2008/0224978 A1
(43) Pub. Date: Sep. 18, 2008

(54) LIQUID CRYSTAL DISPLAY AND DRIVING METHOD THEREOF

(75) Inventor: Jin-woo Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/035,631

(22) Filed: Feb. 22, 2008

(30) Foreign Application Priority Data
Mar. 16, 2007 (KR) 10-2007-0026197

(51) Int. Cl. G09G 3/36

(52) U.S. Cl. 345/92; 345/96

(57) ABSTRACT

A liquid crystal display is capable of minimizing power consumption and providing an excellent image quality by having a varying array wire structure of the liquid crystal display so that the liquid crystal display can employ a low driving voltage and obtain advantages of a dot inversion drive system. Also, a driving method thereof is disclosed.

### CROSS-REFERENCE TO RELATED APPLICATION

This application claims the benefit of Korean Application No. 2007-26197, filed Mar. 16, 2007 in the Korean Intellectual Property Office, the disclosure of which is incorporated herein by reference.

### BACKGROUND OF THE INVENTION

1. Field of the Invention

Aspects of the present invention relate to a liquid crystal display, and more particularly, to a liquid crystal display capable of having improved power consumption characteristics, and a driving method thereof.

2. Description of the Related Art

Generally, a liquid crystal display (LCD) displays an image by using an electric field to control optical transmissivity of liquid crystal. For this purpose, the liquid crystal display (LCD) includes a liquid crystal panel having liquid crystal cells arranged in a matrix arrangement, and a driver to drive the liquid crystal panel.

FIG. 1 is a diagram of a typical liquid crystal display (LCD). As shown in FIG. 1, the typical liquid crystal display (LCD) includes a liquid crystal panel 2 having liquid crystal cells 3 arranged in a matrix of gate lines (GL0 to GLn) and data lines (DL1 to DLm); a gate driver 4 to drive gate lines (GL0 to GLn) of the liquid crystal panel 2; a data driver 6 to drive data lines (DL1 to DLm) of the liquid crystal panel 2; and a timing controller 10 to control the gate driver 4 and the data driver 6.

The liquid crystal panel 2 includes liquid crystal cells 3 formed by thin film transistors (TFT) arranged at every crossing point between the gate lines (GL0 to GLn) and the data lines (DL1 to DLm) and coupled respectively to the liquid crystal cells 3. The thin film transistor (TFT) is turned on by a scan signal, namely a high gate voltage (VGH), which is generated in the gate driver 4 and applied to a gate line (such as GL1) of the liquid crystal panel 2. Accordingly, a data signal is supplied from the data driver 6 to a liquid crystal cell 3, via a data line (such as DL1) of the liquid crystal panel 2.

The thin film transistor (TFT) is turned off if a low gate voltage (VGL) is supplied from the gate lines (GL). Accordingly, the data signal charged in the liquid crystal cell 3 is sustained. The liquid crystal cell 3 includes pixel electrodes which are represented by a liquid crystal capacitor (Clc), which is coupled to the common electrode (Vcom) and the thin film transistor (TFT). The Vcom and the TFT face each other while a liquid crystal is placed between them.

Also, the liquid crystal cell 3 includes a storage capacitor (Cst) in order to stably sustain the charged data signal until another data signal is charged the next time. As arrangements of the liquid crystal having a dielectric anisotropy may be varied according to the data signal that is charged in the liquid crystal cell 5, gray levels of the liquid crystal is implemented by controlling the optical transmissivity thereof.

Also, the gate driver 4 sequentially applies a high gate voltage (VGH) to gate lines (GL0 to GLn) in response to gate control signals (such as, a gate start pulse (GSP), a gate shift clock signal (GSC), and a gate output enable signal (GOE)) from the timing controller 10. Therefore, the thin film transistors (TFT) coupled to the gate lines (GL0 to GLn) are driven, via the gate lines (GL0 to GLn).

The data driver 6 supplies a single line amount of data signals to the respective ones of the data lines (DL1 to DLm) of the liquid crystal panel 2 during each horizontal period (H1, H2, . . . ) in response to the data control signals (such as, a source start pulse (SSP), a source shift clock signal (SSC), a source output enable signal (SOE), and a polarity control signal (POL)) supplied from the timing controller 10. In particular, the data driver 6 converts digital pixel data (red (R), green (G), and blue (B)) supplied from the timing controller 10 into an analog data signal using a gamma voltage supplied from a gamma voltage generation unit (not shown) and supplies the converted analog data signal. The timing controller 10 generates the gate control signals (such as, the GSP, the GSC, and the GOE) to control the gate driver 4, and generates the data control signals (such as the SSP, the SSC, the SOE, and the POL) to control the data driver 6. In addition, the timing controller 10 arranges the pixel data (R, G, B) and supplies the arranged pixel data (R, G, B) to the data driver 6.Such a liquid crystal display is driven using an inversion drive system in order to prevent deterioration of the liquid crystal cells and to improve an image quality. The kinds of inversion drive system include a frame inversion drive system, a dot inversion drive system, and line inversion drive system. Among these, the dot inversion drive system supplies a data signal to each of the liquid crystal cells, the data signal having a different polarity relative to adjacent liquid crystal cells in horizontal or vertical direction.

FIG. 2A and FIG. 2B are diagrams illustrating a dot inversion drive system of a liquid crystal display. As shown in FIG. 2A and FIG. 2B, the polarity of the data signal is reversed in each frame in the horizontal or vertical directions, wherein positive (+) and negative (−) pixel voltage signals are alternately supplied in an alternating current (AC) manner during one vertical period, while a common voltage signal supplied to common lines is supplied in a direct current (DC) manner.

That is to say, in the dot inversion drive system, if a data signal of an odd-numbered field is displayed, then the data signals are supplied to each of the liquid crystal cells so that positive polarity (+) and negative polarity (−) can be alternately displayed as the data signals move from an upper left liquid crystal cell to an upper right liquid crystal cell, which is repeated towards the lower liquid crystal cells, as shown in FIG. 2A. Also, if a data signal of an even-numbered field is displayed, then the data signals are supplied to each of the liquid crystal cells so that negative polarity (−) and positive polarity (+) can be alternately displayed as the data signals move from the upper left liquid crystal cell to the upper right liquid crystal cell, which is repeated towards the lower liquid crystal cells, as shown in FIG. 2B. Such a dot inversion drive system provides an image having an excellent image quality compared to the other inversion drive systems, by offsetting flickers generated between adjacent pixels in the vertical or horizontal direction.

However, the dot inversion drive system has a problem in that power consumption is high due to the high change or variance in the pixel voltage compared to that of the other inversion drive systems, since the polarity of the data signal to the pixel unit is reversed in the horizontal and vertical directions. Also, if the polarity of the data signals is reversed for a common voltage having DC components, a data signal having a large voltage is supplied, resulting in an additional increase in power consumption.

### SUMMARY OF THE INVENTION

Accordingly, aspects of the present invention are designed to provide a liquid crystal display capable of minimizing power consumption characteristics of a liquid crystal display, while providing an excellent image quality by varying an array wire structure of the liquid crystal display so that the liquid crystal display can employ a low driving voltage (for example, 5V) and obtain the advantages of a dot inversion drive system, and a driving method thereof.

According to an aspect of the present invention, a liquid crystal display includes a liquid crystal panel including gate lines arranged in one direction, data lines arranged to be crossed with the gate lines, liquid crystal cells arranged in a matrix with thin film transistors formed corresponding to every crossing points between the gate lines and the data lines and coupled respective ones of the liquid crystal cells; a gate driver to supply a scan pulse to the gate lines of the liquid crystal panel; a data driver to supply a pixel voltage signal to the data lines of the liquid crystal panel; and a line buffer memory device coupled with the data driver, to supply different polarities of the pixel voltage signal to the data lines of the liquid crystal panel during each horizontal line period, wherein the liquid crystal cells are arranged in a zigzag course relative to a corresponding one of the gate lines and coupled thereto to be driven via the one gate line.

According to another aspect of the present invention, a method of driving a liquid crystal display including gate lines arranged in one direction and data lines arranged to be crossed with the gate lines; thin film transistors coupled in a zigzag course along corresponding ones of the gate line; and liquid crystal cells formed corresponding to every crossing point between the gate lines and the data lines, and coupled to respective ones of the thin film transistors and arranged in a zigzag course relative to a corresponding one of the gate lines, the method including supplying a scan pulse to the gate lines of the liquid crystal panel; generating a pixel voltage signal to be applied to the data lines of the liquid crystal panel; and supplying a reversed polarity of the pixel voltage signal to the data lines of the liquid crystal panel during each horizontal line period.

According to another aspect of the present invention, a display device includes: a plurality of first signal lines formed in a first direction; a plurality of second signal lines formed in a second direction so as to cross the first signal lines; and a plurality of thin film transistors, each of which respectively corresponds to one of the first signal lines and to one of the second signal lines, wherein respective ones of the thin film transistors are arranged sequentially along the one second signal line in the second direction to be connected thereto from each one of two sides of the second signal line in an alternating manner.

According to another aspect of the present invention, a display device includes: a plurality of data lines; a plurality of gate lines to cross the plurality of data lines; and a plurality of thin film transistors formed along the gate lines and which correspond alternately to odd or even cells of the display device, wherein the odd cells are associated with respective one of the plurality of gate lines and even cells are associated with respective one of the gate lines that is immediately adjacent thereto.

According to another aspect of the present invention, a method of driving a display device includes; providing a data signal to a plurality of data lines; providing a gate signal to a plurality of gate lines that cross the plurality of data lines; and switching a plurality of thin film transistors formed along the gate lines and which correspond alternately to odd or even cells of the display device, wherein the odd cells are associated with respective ones of the plurality of gate lines and even cells are associated with the respective ones of the gate lines that is immediately adjacent thereto.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a diagram of a typical liquid crystal display;

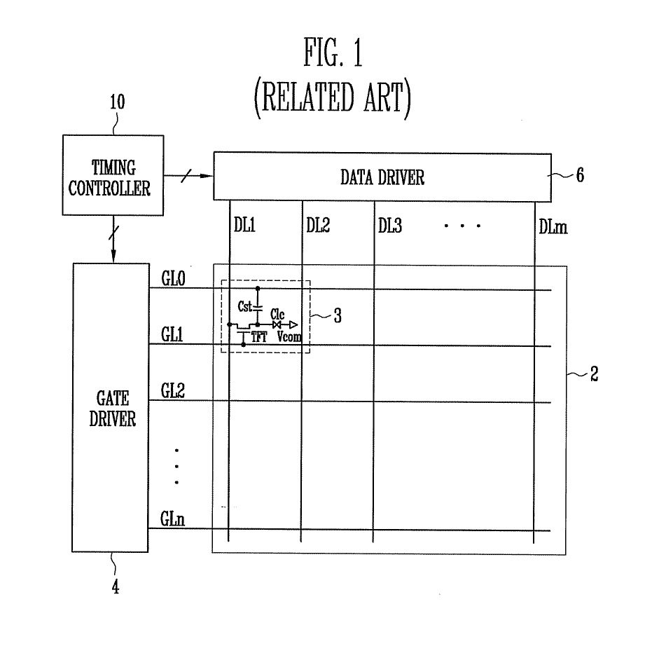

FIG. 2A and FIG. 2B are diagrams illustrating a dot inversion drive system of the typical liquid crystal display;

FIG. 3A and FIG. 3B are diagrams illustrating a line inversion drive system of a liquid crystal display according to an aspect of the present invention;

FIG. 4 is a waveform view illustrating a line inversion drive system as shown in FIG. 3A and FIG. 3B; and

FIG. 5 is a block view showing a panel configuration of a liquid crystal display according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

Hereinafter, certain aspects according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity.

In the specific description of aspects of the present invention, a description of a line inversion drive system in which a problem of the dot inversion drive system, namely a high power consumption characteristic, is addressed, as well as other problems and advantages.

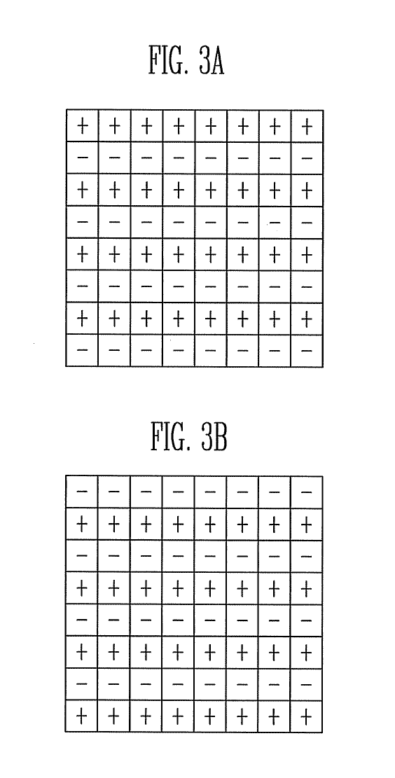

As shown in FIG. 3A and FIG. 3B, a line inversion drive system is a system driven so that polarity of data signals supplied to a liquid crystal panel can be reversed according to each gate line and each frame. In FIGS. 3A and 3B, the polarities of the data signals supplied to respective ones of the gate lines are identical to each other. That is, each gate line receives data signals of a same polarity. Also, as shown in FIGS. 3A and 3B in the case of the line inversion drive system, the polarity of the data signal is reversed for each gate line relative to immediately adjacent gate lines, and then a common voltage corresponding to the polarity of the data signal is also reversed.

For example, when the first gate line is driven, the data signals are supplied to have a positive polarity (+), the common voltage is supplied to have a negative polarity (−), while the polarities of the data signals and the common voltage are reversed in the next gate lines. That is to say, when the second gate line is driven, the data signals are supplied to have the negative polarity (−) and the common voltage is supplied to have the positive polarity (+).

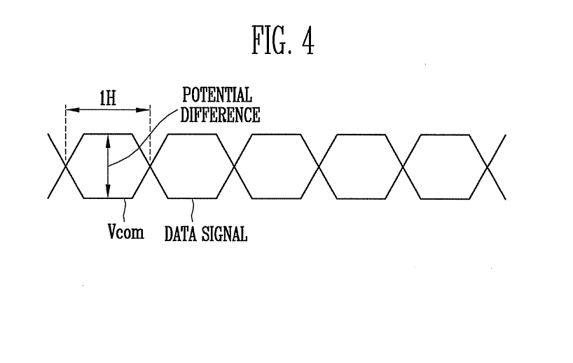

FIG. 4 is a waveform view illustrating a line inversion drive system as shown in FIG. 3A and FIG. 3B. As shown, in the line inversion drive system of FIG. 3A and FIG. 3B, the polarity of the data signals is reversed in the alternating gate lines, namely during each first horizontal period (1H), and the polarity of a common voltage (Vcom) corresponding to the polarity of the data signals is also correspondingly reversed. FIG. 4 is a diagram shown on the assumption that data signals having the same capacity are supplied to each gate line. However, in practice, the data signals supplied to each gate line actually have a different capacity in order to display an image with various gray levels.

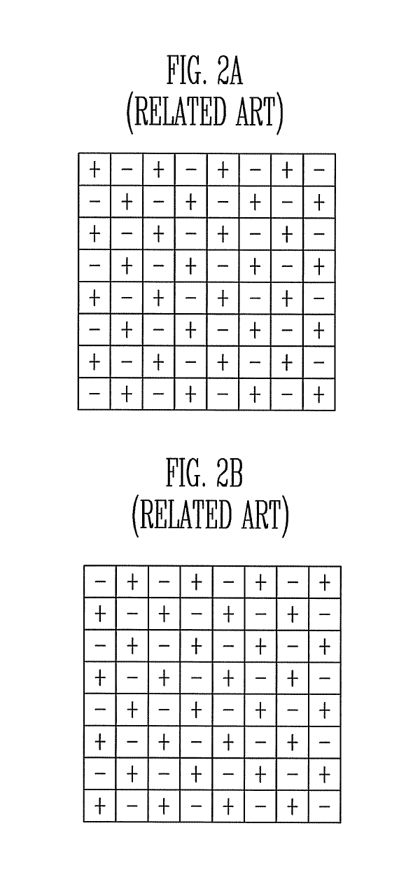

In the dot inversion drive system as described in connection with FIGS. 2A and 2B, a voltage of the data signals should be changed to ensure that a predetermined potential difference exists between the common voltage and the data signal, since the DC component common voltage is fixed, which causes a supply level of the data signals to be relatively high and causes the increase in power consumption. However, the line inversion drive system according to an aspect of the present invention has a predetermined potential difference between the data signal and the common voltage even though a relatively low data signals are supplied, since the common voltage (Vcom) is reversed to correspond to the data signals.

Accordingly, fewer problems are encountered in displaying an image even if a relatively low data signal is applied in the line inversion drive system, and the power consumption may be reduced significantly compared to that of the dot inversion drive system. Also, the size and cost of the data driver may be reduced significantly since the polarity is reversed in gate line units rather than dot units (that is, for each gate line, rather than for each dot).

The line inversion drive system according to an aspect of the present invention has an advantage in that the power consumption may be reduced. The line inversion drive system according to an aspect of the present invention may also achieve display of an image having an excellent image quality when compared to the dot inversion drive system by offsetting flickers generated among adjacent pixels in a vertical or horizontal direction as is the case described in the dot inversion drive system.

Accordingly, aspects of the present invention provide a liquid crystal display capable of minimizing power consumption characteristics, while providing an excellent image quality by varying an array wire structure of the liquid crystal display so that the liquid crystal display can be driven with a low driving voltage (for example, 5V) and positive effects of a dot inversion drive system can be obtained using the line inversion drive system.

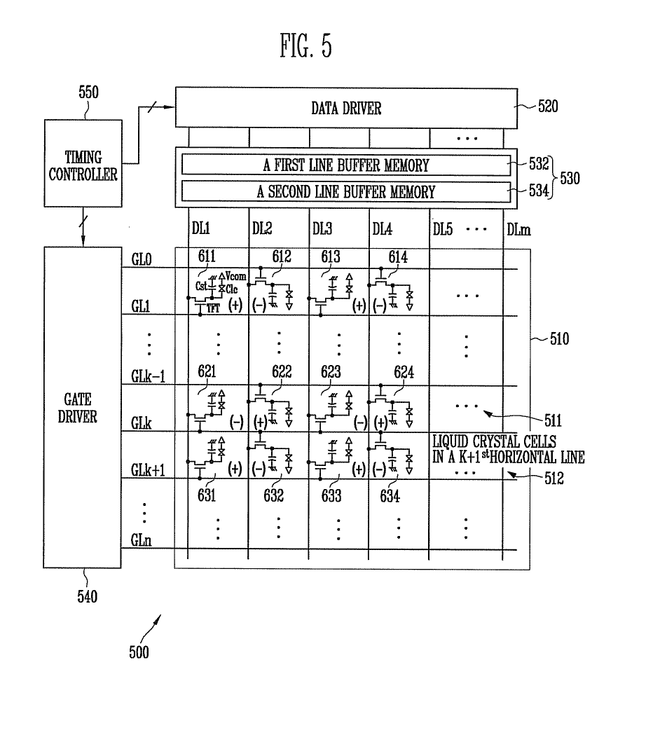

FIG. 5 is a block view showing a panel configuration of a liquid crystal display according to an aspect of the present invention. Referring to FIG. 5, the liquid crystal display 500 includes a liquid crystal panel 510 including liquid crystal cells 611-614, 621-624, and 631-634 formed by; a matrix of a gate driver 540 to drive gate lines (GL0 to GLn) of the liquid crystal panel 510 and a data driver 520 to drive data lines (DL1 to DLm) of the liquid crystal panel 510; and a timing controller 550 to control the gate driver 540 and the data driver 520.

Also, the liquid crystal display 500 further includes a buffer memory device 530. The buffer memory device 530 further includes a first line buffer memory 532 and a second line buffer memory 534, which are coupled to (or may be included in) the data driver 520. The negative (−) and positive (+) pixel voltage signals generated in the data driver 520 are sequentially supplied to each of the liquid crystal cells 611-614, 621-624, and 631-634 in the liquid crystal panel 510 through the first line buffer memory 532 and the second line buffer memory 534 whenever a gate signal is applied to the gate lines (GL0 to GLn) to turn on the thin film transistors of the respective liquid crystal cells 611-614, 621-624, and 631-634.

The liquid crystal cells 611-614, 621-624, and 631-634 are formed by thin film transistors (TFTs) formed at every crossing point in the matrix between the gate lines (GL0 to GLn) and the data lines (DL1 to DLm). The thin film transistor (TFT) is supplied with a pixel voltage signal that is supplied from the corresponding data line (DL) to the liquid crystal cells 611-614, 621-624, and 631-634 in response to the scan signal, namely the gate signal that is supplied from the corresponding gate line.

In the aspect shown in FIG. 5, the thin film transistors (TFT) are coupled to respective ones of the gate lines (GL) in a zigzag course. Therefore, the liquid crystal cells 611-614, 621-624, and 631-634 driven by the respective gate lines (GL) are arranged in the zigzag course on the basis of the corresponding gate lines (GL). For example, for gate line GLk, the liquid crystal cells 621, 632, 623, and 634 are arranged in a zigzag pattern relative to the gate line GLk. Similarly, for gate line GLk−1, liquid crystal cells 622 and 624 are arranged in a zigzag pattern relative to the gate line GLk−1.

That is to say, for example, odd-numbered liquid crystal cells from among all the liquid crystal cells in along corresponding ones of horizontal lines are coupled to respective one of the gate lines formed in lower sides of the of the liquid crystal cells, and even-numbered liquid crystal cells from among all the liquid crystal cells along the corresponding one of the horizontal lines are coupled to respective one of the gate lines formed in upper sides of the liquid crystal cells.

That is to say, in FIG. 5, for example, odd-numbered liquid crystal cells 611 and 613 of the liquid crystal cells 611-614 in a horizontal linear arrangement are coupled to a gate line GL1 formed in lower sides of the liquid crystal cells 611-614, and even-numbered liquid crystal cells 612 and 614 of the liquid crystal cells 611-614 in a horizontal linear arrangement are coupled to a gate line GL0 formed in upper sides of the liquid crystal cells 611-614.

Accordingly, the liquid crystal cells constituting the same horizontal lines are alternately driven by the different gate lines (GL) for every column along the same horizontal line. Therefore, whenever each of the gate lines (GL) is driven, the liquid crystal cells in a zigzag course are driven from among the liquid crystal cells that are arranged into two adjacent horizontal lines. Therefore, each of the horizontal lines of the liquid crystal cells is driven by two gate lines (GL).

That is to say, as shown in FIG. 5, the liquid crystal cells 621, 623 in the odd-numbered columns (DL1 and DL3) out of the liquid crystal cells 621-624 in a kth horizontal line (511) are driven by a kth gate line (GLk), while the liquid crystal cells 622, 624 in the even-numbered columns (DL2 and DL4) out of the liquid crystal cells 621-624 in the kth horizontal line (511) are driven by a k−1st gate line (GLk−1). Also, in the same manner as described above, the liquid crystal cells 632, 634 in the even-numbered columns (DL2 and DL4) out of the liquid crystal cells 631-634 in a k+1st horizontal line (512) are driven by the kth gate line (GLk), while the liquid crystal cells 631, 633 in the odd-numbered columns (DL1 and DL3) out of the liquid crystal cells 631-634 in a k+1st horizontal line (512) are driven by a k+1st gate line (GLk+1).

Accordingly, with respect to the liquid crystal cells 631-634 in the k+1st horizontal line (512), the liquid crystal cells 632, 634 in the even-numbered columns (DL2 and DL4) are driven by the kth gate line (GLk), and the liquid crystal cells 631, 633 in the odd-numbered columns (DL1 and DL3) are driven by the k+1st gate line (GLk+1).

Also, when each of the gate lines (GL0 to GLn) is driven, the negative (−) and positive (+) pixel voltage signals supplied from the data driver 520 are sequentially applied to the liquid crystal cells 611-614, 621-624, and 631-634 through the first and second line buffer memories 532, 534.

As described above, the liquid crystal cells (for example, 621-624 and 631-634) arranged in two adjacent horizontal lines (for example, 511 and 512) in a zigzag course are driven whenever the gate lines (GL0 to GLn) are driven. Therefore, a pixel voltage signal may be applied to the liquid crystal cells in a line inversion drive system fashion, and yet the liquid crystal panel 12 may have the same effects as in the dot inversion drive system.

For example, when the kth gate line (GLk) is driven during an ith frame period as shown in FIG. 5, a negative (−) pixel voltage signal is applied to the odd-numbered liquid crystal cells (621, 623) in the kth horizontal line (511) and the even-numbered liquid crystal cells (632, 634) in the k+1st horizontal line (512) through the first line buffer memory (532). Accordingly, the odd-numbered liquid crystal cells (621, 623) and the even-numbered liquid crystal cells (632, 634) that correspond to the kth gate line (GLk) are charged with the negative (−) pixel voltage signal. Also, when the adjacent k+1st gate line (GLk+1) is driven, a positive (+) pixel voltage signal is applied to the odd-numbered liquid crystal cells (631, 633) in the k+1st horizontal line (512) and the even-numbered liquid crystal cells (not shown) in the k+2nd horizontal line (not shown) through the second line buffer memory (534). Accordingly, the odd-numbered liquid crystal cells (631, 633) and the even-numbered liquid crystal cells (not shown) that correspond to the k+1st gate line (GLk+1) are charged with the positive (+) pixel voltage signal. Thus, as shown in FIG. 5, the liquid crystal cells corresponding respectively to the horizontal lines are driven with different polarity from those of the adjacent liquid crystal cells.

As shown in FIG. 5, in the case of the liquid crystal cells in the k+1st horizontal line (512), it is confirmed that the positive (+) pixel voltage signal is applied to the odd-numbered liquid crystal cells (631, 633), and the negative (−) pixel voltage signal is applied to the even-numbered liquid crystal cells (not shown). Here, a negative (−) pixel voltage signal is outputted from the first line buffer memory 532 and a positive (+) pixel voltage signal is outputted from the second line buffer memory 534 during the ith frame period. On the contrary, a positive (+) pixel voltage signal is outputted from the first line buffer memory 532 and a negative (−) pixel voltage signal is outputted from second line buffer memory 534 during an i−1st or i+1st frame period.

Accordingly, the liquid crystal display 500 according to an aspect of the present invention is actually driven in the line inversion drive system, but driven with different polarities in every adjacent liquid crystal cells. As a result, the liquid crystal display 500 has the same effect as in the dot inversion drive system. Accordingly, the liquid crystal display 500 may be useful to reduce power consumption, which is problematic for the typical dot inversion drive system, but realize an excellent image quality, which is a merit of the dot inversion drive system.

However, in aspects of the present invention, for the liquid crystal cells being coupled to the first gate line (GL0) and the last gate line (GLn), the data signal should be applied to liquid crystal cells at the same time, while the data (pixel voltage signal) should be used once more upon the first and second line buffer memories 532, 534. Also, the timing controller 550 supplies pixel data signal (R, G, B Data), inputted from the outside, to the data driver 520. Also, the timing controller 550 generates a data control signal (DDC) and a gate control signal (GDC) to control the data driver 520 and the gate driver 540 in response to control signals inputted from the outside.

In aspects of the present invention, the gate control signals (GDC) includes a gate start pulse (GSP), a gate shift clock signal (GSC), a gate output enable signal (GOE), etc. The data control signals (DDC) includes a source start pulse (SSP), a source shift clock signal (SSC), a source output enable signal (SOE), a polarity control signal (POL), etc.

The data driver 520 supplies a pixel signal of one horizontal line to the data lines (DL1 to DLm) during each horizontal period (H1, H2, . . . ) in response to the data control signals (DDC) supplied from the timing controller 550. In particular, the data driver 520 converts digital pixel data (R, G, B), supplied from the timing controller 550, into an analog pixel signal using a gamma voltage supplied from a gamma voltage generation unit (not shown) and supplies the converted analog pixel signal.

However, in an aspect of the present invention, a line buffer memory device 530 is coupled to or includes the data driver 520, and then the different polarities of the pixel voltage signal is supplied through the line buffer memory device 530 in the line inversion drive system during every horizontal line period. Also, a gate driver 540 sequentially supplies a scan pulse to the gate lines (GL1 to GLn) in response to the gate control signals (GDC) supplied from the timing controller 550. Therefore, the gate driver 540 allows the thin film transistors (TFT) coupled to the gate lines (GL1 to GLn) to be driven by a gate line (GL) unit (not shown). For this purpose, the gate driver 540 includes a shift register (not shown) to sequentially generate a scan pulse; a level shifter (not shown) to shift a swing width of a scan pulse voltage to a suitable level to drive a liquid crystal cell (Clc); a buffer coupled between the level shifter and the gate line (GL) to serve as a voltage follower.

As described above, the liquid crystal display according to aspects of the present invention may be useful to minimize power consumption and also provide improved image quality by varying an array wire structure of the liquid crystal display so that the liquid crystal display can employ a low driving voltage (for example, 5V) and obtain positive effects of a dot inversion drive system.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A liquid crystal display, comprising:
a liquid crystal panel including gate lines arranged in one direction, data lines arranged to be crossed with the gate lines, liquid crystal cells arranged in a matrix with thin film transistors formed corresponding to every crossing points between the gate lines and the data lines and coupled to respective ones of the liquid crystal cells;
a gate driver to supply a scan pulse to the gate lines of the liquid crystal panel;
a data driver to supply a pixel voltage signal to the data lines of the liquid crystal panel; and
a line buffer memory device coupled with the data driver, to supply different polarities of the pixel voltage signal to the data lines of the liquid crystal panel during each horizontal line period,
wherein the liquid crystal cells are arranged in a zigzag course relative to a corresponding one of the gate lines and coupled thereto to be driven via the one gate line.

2. The liquid crystal display according to claim 1, wherein the liquid crystal cells are arranged in a zigzag course by connecting odd-numbered liquid crystal cells among the liquid crystal cells in one horizontal line to the gate lines formed in a first side of the horizontal line, and connecting even-numbered liquid crystal cells to the gate lines formed in a second side of the horizontal line.

3. The liquid crystal display according to claim 1, wherein the line buffer memory device includes:
a first line buffer memory to supply a positive (+) or negative (−) pixel voltage signal, provided via the data driver, to the data lines of the liquid crystal panel during a first horizontal line period; and
a second line buffer memory to supply a pixel voltage signal to the data lines of the liquid crystal panel during a second horizontal line period,
wherein the pixel voltage signal has an opposite polarity from that of the pixel voltage signal supplied from the first line buffer memory.

4. The liquid crystal display according to claim 3, wherein the positive (+) and negative (−) pixel voltage signals supplied from the data driver via the first and second line buffer memories are sequentially applied to the liquid crystal cells in each horizontal line period.

5. The liquid crystal display according to claim 1, further comprising a timing controller to generate a control signal to supply pixel data signal (red (R), green (G), blue (B) Data), that is inputted from an outside thereof, to the data driver, and to control the data driver and the gate driver in response to the control signal inputted from the outside.

6. A method of driving a liquid crystal display including gate lines arranged in one direction and data lines arranged to be crossed with the gate lines; thin film transistors coupled in a zigzag course along corresponding ones of the gate line; and liquid crystal cells formed corresponding to every crossing point between the gate lines and the data lines, and coupled to respective ones of the thin film transistors and arranged in a zigzag course relative to a corresponding one of the gate lines, the method comprising:
supplying a scan pulse to the gate lines of the liquid crystal panel;
generating a pixel voltage signal to be applied to the data lines of the liquid crystal panel; and
supplying a reversed polarity of the pixel voltage signal to the data lines of the liquid crystal panel during each horizontal line period.

7. The method of driving a liquid crystal display according to claim 6, wherein the liquid crystal cells are arranged in a zigzag course by connecting odd-numbered liquid crystal cells among the liquid crystal cells in one horizontal line to the gate lines formed in a first side of the horizontal line, and connecting even-numbered liquid crystal cells to the gate lines formed in a second side of the horizontal line.

8. The method of driving a liquid crystal display according to claim 6, wherein the pixel voltage signal is reversed into one of a positive polarity (+) and a negative polarity (−) during each horizontal line period and sequentially applied to the corresponding liquid crystal cells.

9. A display device comprising:
a plurality of first signal lines formed in a first direction;
a plurality of second signal lines formed in a second direction so as to cross the first signal lines; and
a plurality of thin film transistors, each of which respectively corresponds to one of the first signal lines and to one of the second signal lines,
wherein respective ones of the thin film transistors are arranged sequentially along the one second signal line in the second direction to be connected thereto from each one of two sides of the second signal line in an alternating manner.

10. The display device of claim 9, wherein for the one second signal line, alternating ones of the first signal lines supply different polarity voltage signals.

11. The display device of claim 10, further comprising a first line buffer memory and a second line buffer memory to respectively supply the alternating ones of the different polarity voltage signals.

12. A display device comprising:
a plurality of data lines;
a plurality of gate lines to cross the plurality of data lines; and
a plurality of thin film transistors formed along the gate lines and which correspond alternately to odd or even cells of the display device,
wherein the odd cells are associated with respective one of the plurality of gate lines and even cells are associated with respective one of the gate lines that is immediately adjacent thereto.

13. The display device of claim 12, wherein the plurality of data lines include a plurality of first data lines and a plurality of second data lines, and the odd cells are associated with the first data lines and the respective one gate line, and the even cells are associated with the second data lines and the respective one gate line that is adjacent.

14. The display device of claim 12, wherein the odd cells receive a voltage signal of a first polarity and the even cells receive a voltage signal of a second polarity that is different from the first polarity.

15. The display device of claim 12, further comprising a line buffer memory device to provide voltage signals of a first polarity and a second polarity that is different from the first polarity.

16. The display device of claim 15, wherein the line buffer memory device comprises:
a first line buffer memory to provide one of the voltage signals of a first polarity; and
a second line buffer memory to provide one of the voltage signals of a second polarity.
